(19) United States
(12) Patent Application Publication
(10) Pub. No.: US 2005/0038527 A1
(43) Pub. Date: Feb. 17, 2005

(54) Apparatus and method for programming a motor control of a motor

(76) Inventors: Vivek Kulkarni, Hyderabad (IN); Derek S. Adelman, Fort Wayne, IN (US); Srinivasa D. Rao, Hyderabad (IN); Roger C. Becerra, Fort Wayne, IN (US); Brian L. Beifus, Fort Wayne, IN (US); Thota N.V. Rangababu, Secunderabad (IN)

Correspondence Address: Philmore H. Colburn II;Cantor Colburn LLP, 55 Griffin Road South, Bloomfield, CT, 06002, US

(21) Appl. No.: 10/631,873

(22) Filed: Jul. 30, 2003

(51) Int. Cl. G05B 11/01

(52) U.S. Cl. 700/14; 700/306

(57) ABSTRACT

An interface for programming a motor control of a motor includes a microcontroller in signal communication with a first signal port and a second signal port, and a solid state relay in signal communication with the microcontroller and the second signal port. The solid state relay includes a control element responsive to first and second signals from the microcontroller for turning on power and for turning off power, respectively, to the motor control, wherein the microcontroller is adapted for sending a programming signal from the computer to the motor control in response to the programming signal being sent within a defined time following the control element turning on power to the motor control.

### BACKGROUND OF THE INVENTION

The present disclosure relates generally to an apparatus and method for programming a motor control of a motor, and particularly to a programming interface having upgrade capability.

An electronically commutated motor (ECM) having a motor control may be programmed with specific operating parameters, thereby providing an efficient and reliable motor design for various types of applications. To program the motor, a programming interface may be connected between a personal computer (PC) and the motor control, and operating parameters downloaded to a memory at the motor control. As a result, two physically identical motors may be programmed for substantially different application requirements. The interface may also be used for troubleshooting and testing the ECM. However, as new features and functions become available for ECMs, or as new ECM designs become available, the programming of these ECMs may require the acquisition of a new programming interface having the appropriate firmware. Accordingly, there remains a need in the art for a programming interface for ECMs that can program existing ECMs, can program new features and functions into existing ECMs, and can program new ECM designs, without the need to purchase a complete new programming interface.

### SUMMARY OF THE INVENTION

In one embodiment, an interface for programming a motor control of a motor includes a microcontroller in signal communication with a first signal port and a second signal port, and a solid state relay in signal communication with the microcontroller and the second signal port. The solid state relay includes a control element responsive to first and second signals from the microcontroller for turning on power and for turning off power, respectively, to the motor control, wherein the microcontroller is adapted for sending a programming signal from the computer to the motor control in response to the programming signal being sent within a defined time following the control element turning on power to the motor control.

In another embodiment, a method for programming a motor control of motor is disclosed. A reset signal is received at an interface from a computer, the reset signal being representative of a user request to program the motor control. In response to the reset signal, a ready signal is generated at the interface and power is turned on at the interface to the motor control. Following the power-on sequence, a programming signal received at the interface from the computer within a defined time following the power being turned on to the motor control may be communicated to the motor control.

In a further embodiment, a method for testing a cable connection between an interface and a motor control is disclosed. A cable test request signal is received at an interface from a computer. A cable test signal is sent from the interface on a signal line to the motor control, and in response thereto, a return test signal is received on a cable check line. The value of the return test signal is compared to a comparator threshold value, and in response to the comparator threshold value exceeding the value of the return test signal, a cable test failure signal is provided.

### BRIEF DESCRIPTION OF THE DRAWINGS

Referring to the exemplary drawings wherein like elements are numbered alike in the accompanying Figures:

FIG. 1 depicts an exemplary programming system employing an interface in accordance with an embodiment of the invention;

FIG. 2 depicts a one-line block diagram of an exemplary interface for use in the system of FIG. 1;

FIGS. 3-12 depict schematic representations of various architectural areas of the interface of FIG. 2; and

FIG. 13 depicts exemplary interface signals in accordance with an embodiment of the invention.

### DETAILED DESCRIPTION OF THE INVENTION

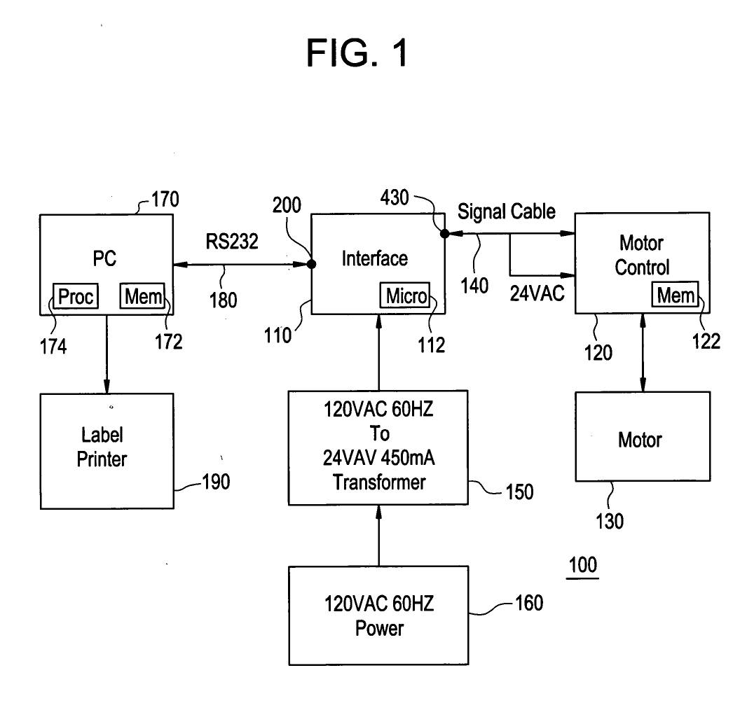

FIG. 1 is an exemplary embodiment of a programming system 100 employing an interface 110 for programming a motor control 120 of a motor 130. In an embodiment, motor 130 is an electronically commutated motor (ECM) with motor control 120 integral therewith, and with signal communication between interface 110 and motor control 120 being accomplished via a signal/power cable 140. In an embodiment, signal/power cable 140 has six signal lines and two power lines with an RJ45 connector at one end for connection to interface 110, and with motor control connectors at the other end for connection to motor control 120. In this manner, interface 110 may communicate with motor control 120 through the use of a standard 8-channel network cable. In an embodiment, the two power lines provide power at 24 VAC (volts alternating current) to motor control 120, which is provided by a transformer 150. Transformer 150 receives power 160 at 120 VAC and 60 Hz (Hertz) and delivers the 24 VAC power with a current rating of 450 mA (milliamps). The voltage, current and frequency ratings of transformer 150 are exemplary only, and it will be appreciated that other ratings may be employed depending on locally available power. Transformer 150 may be a wall mounted transformer, integrally arranged with interface 110, or arranged in any other manner suitable for the application described herein. The power from transformer 150 is used to power up interface 110 and the electronics in motor control 120.

Interface 110 communicates with motor control 120 through the use of a computer 170, such as personal computer (PC) or laptop computer, for example, with an RS232 serial communication port and connected cable 180. In an alternative embodiment, interface 110 communicates with computer 170 via wireless communication. Computer 170 includes a memory 172 for storing executable instructions and a processor 174 for executing the instructions. In an embodiment, the executable instructions are embodied in either a DOS-based application program or a Windows-based application program, however, other programming language may be employed. The application program sends serial data through the communication port and RS232 cable 180 to a microcontroller 112 at interface 110, which is used to initialize (reset) and send instructions to microcontroller 112. In an embodiment, the main instructions that the application program will send to microcontroller 112 are: read motor control memory 122; write to motor control memory 122; perform a cable check; and, perform an optoelectric isolator check. After performing these actions, microcontroller 112 will send a response back informing the application program of the test results. Microcontroller 112 serves to control the data flow from computer 170 to motor control 120 and back, and acts as a switch that controls when motor control 120 receives power and when it does not.

A label printer 190 may be connected to computer 170, which may be used to print a label to be attached to motor control 120 after motor control 120 has been programmed via interface 110. An exemplary label contains five lines of information. The first line contains the company's name where motor 130 will be used, and the other four lines contain any information that the user may wish to place on the label.

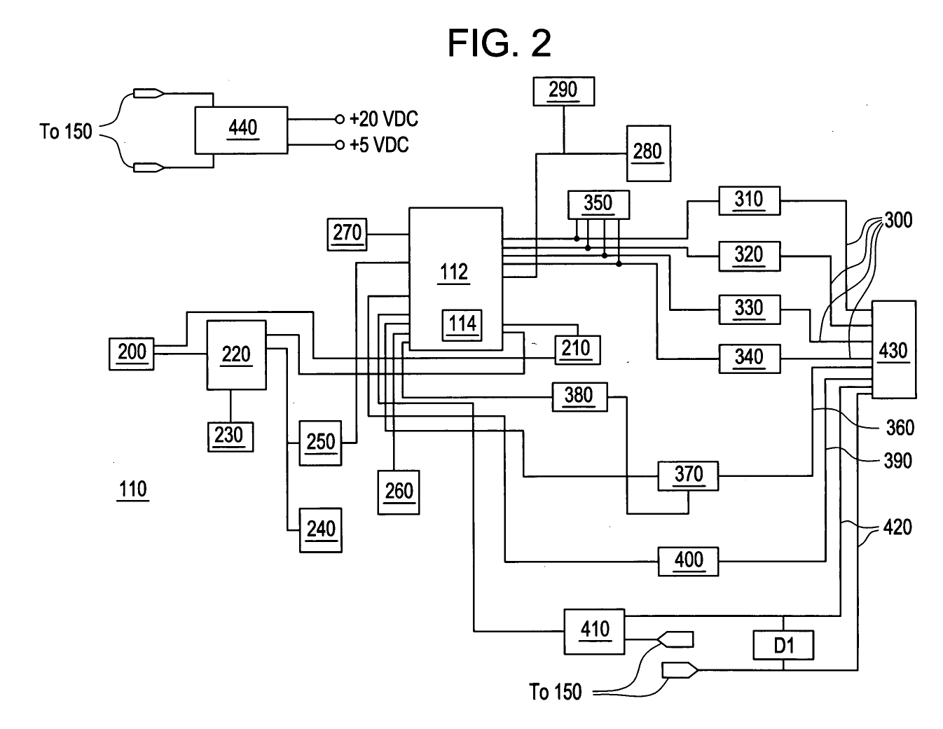

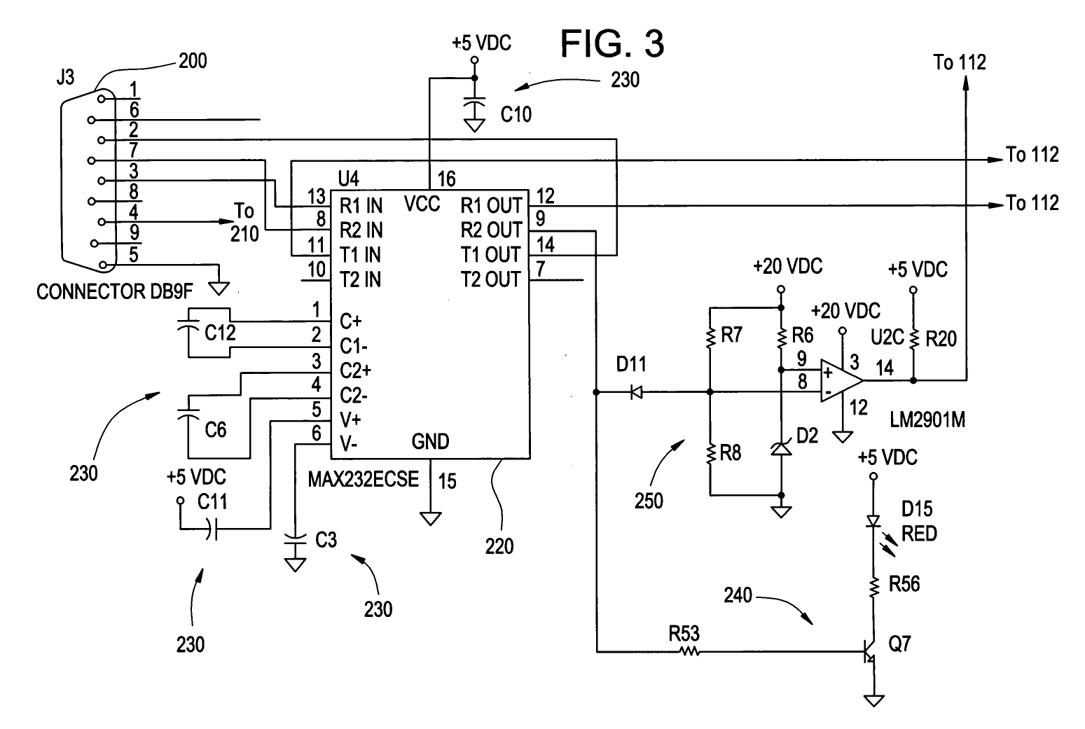

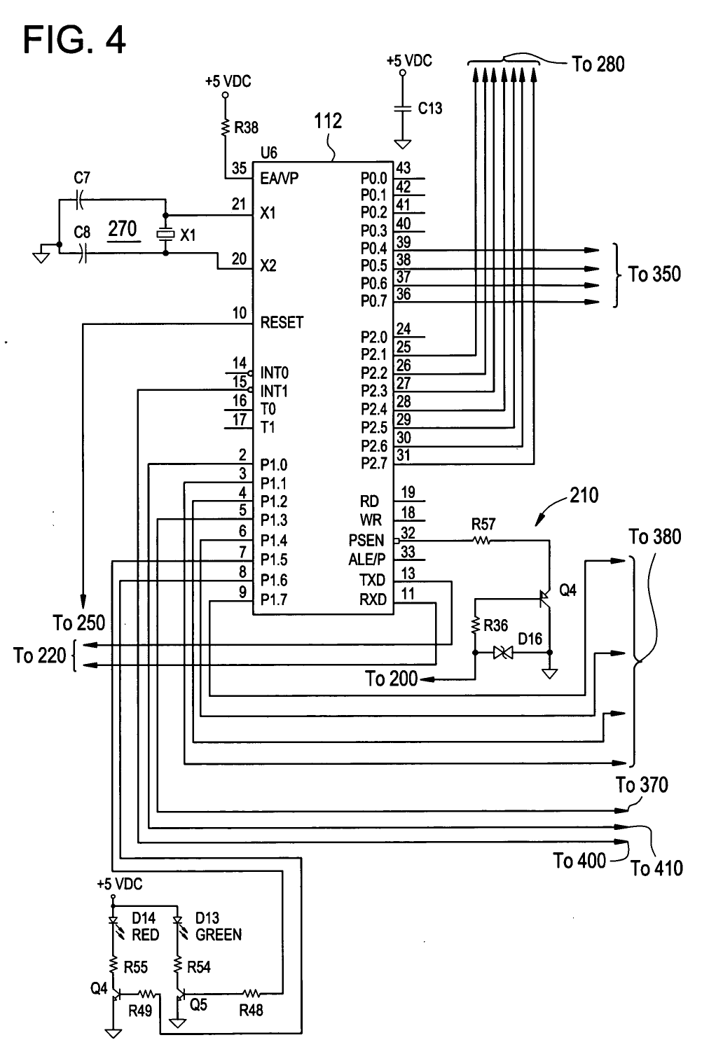

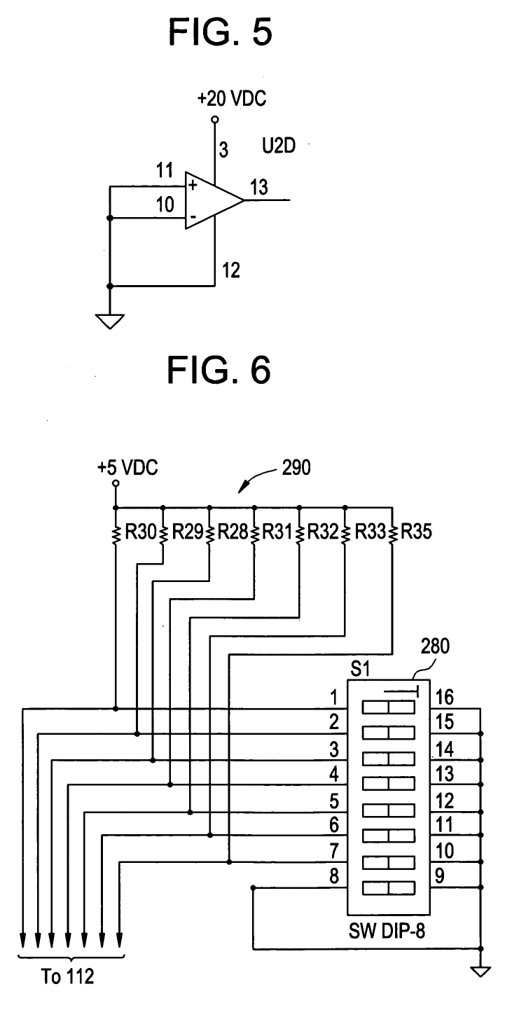

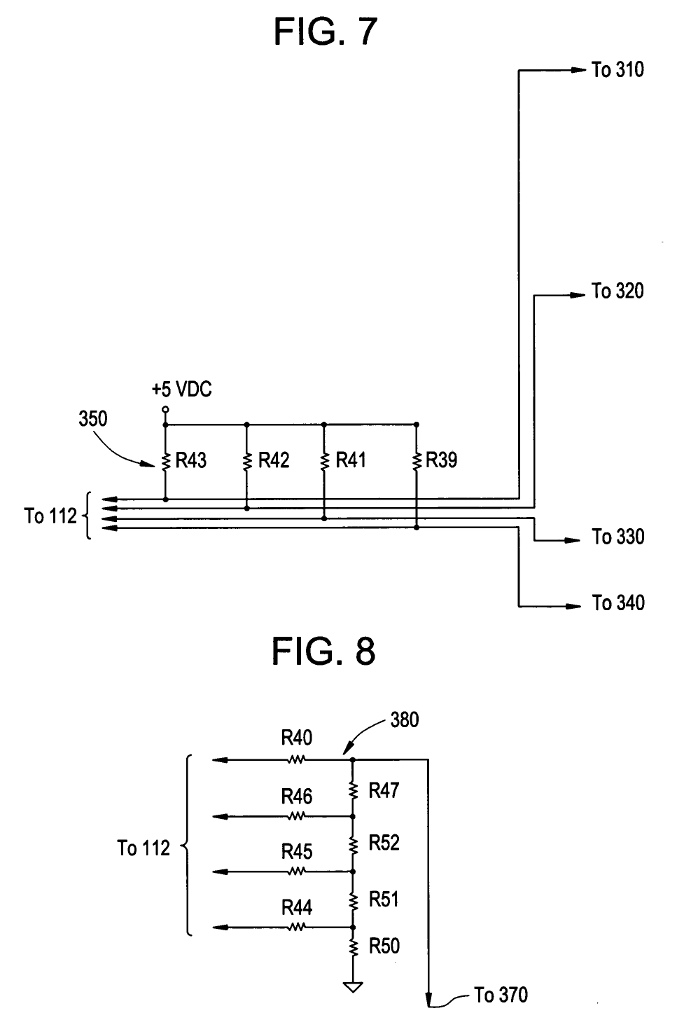

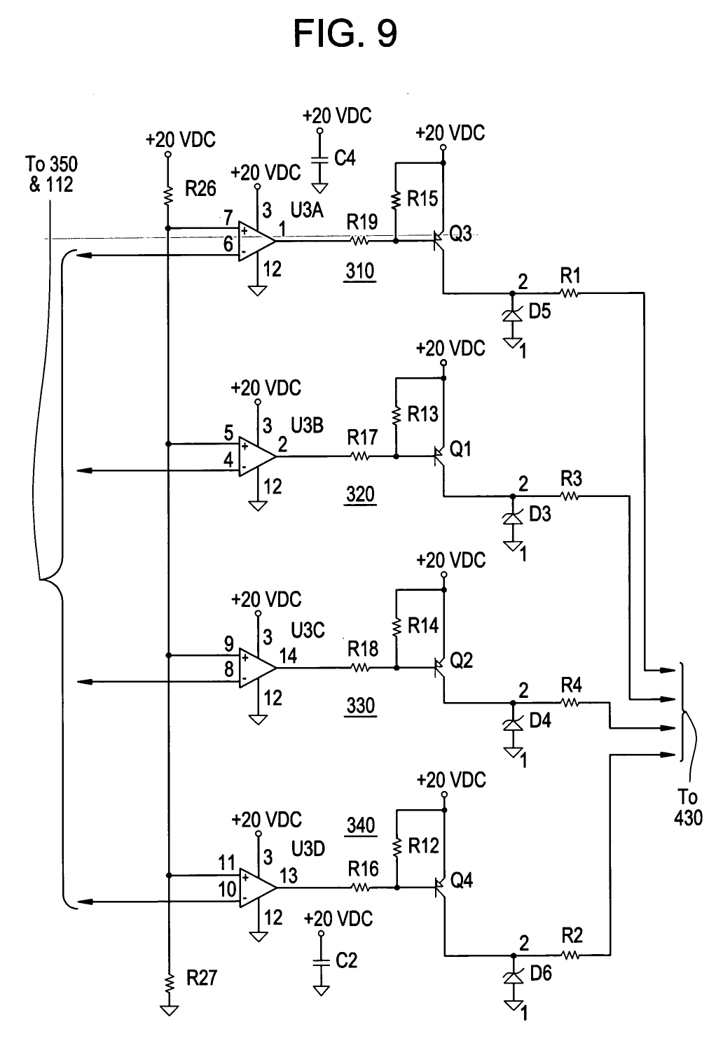

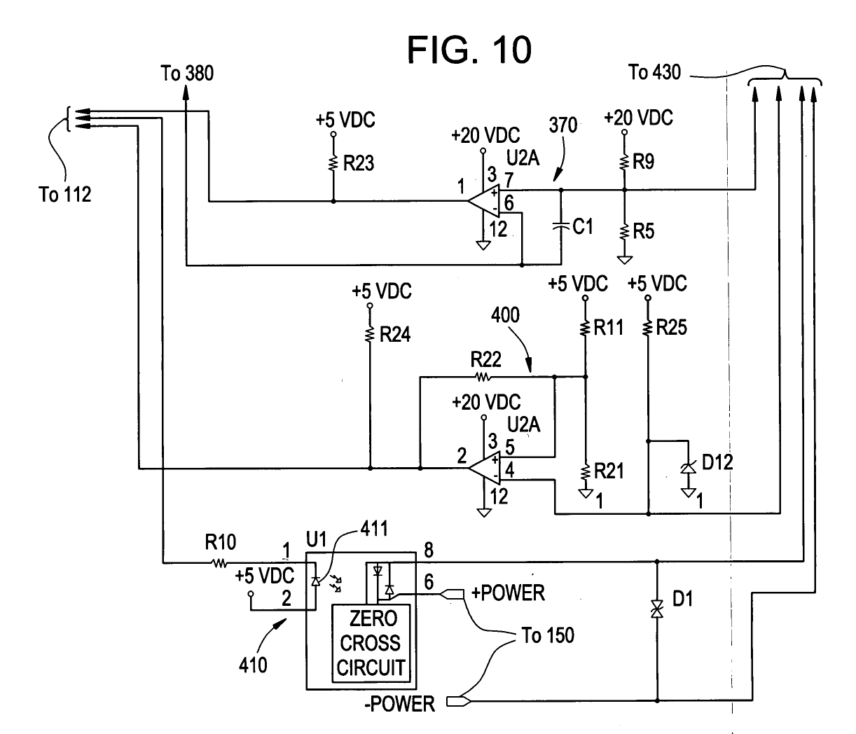

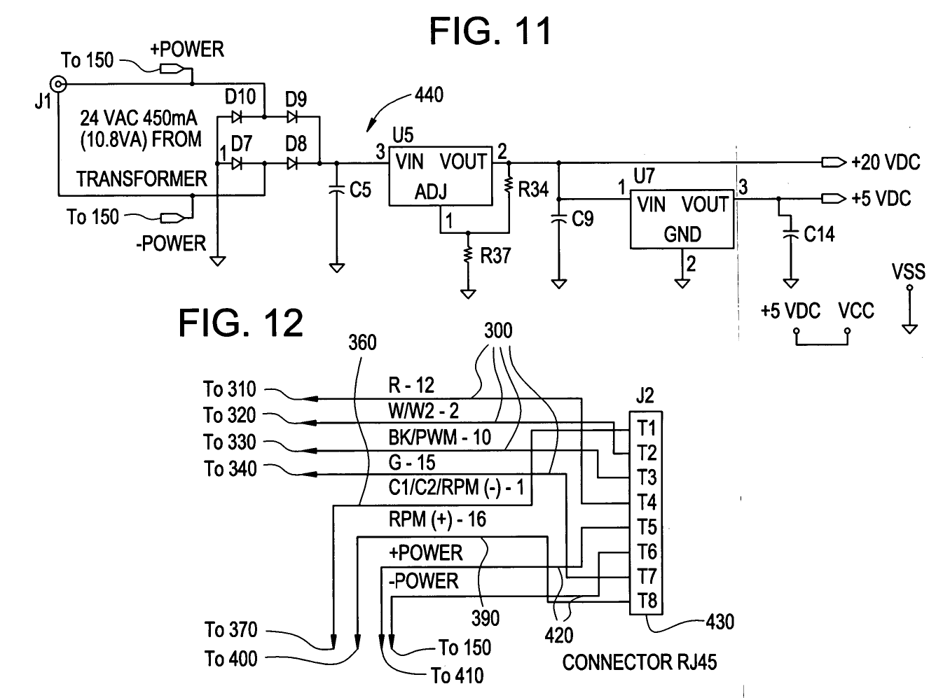

The architecture and functioning of interface 110 will now be described with reference to FIGS. 2-12, where FIG. 2 depicts a one-line block diagram of interface 110, and FIGS. 3-12 depict detailed schematic representations of various architectural areas of interface 110. Interconnecting lines between blocks or architectural elements depict signal communication paths.

Computer 170 sends serial data through four lines at connector 200 (alternatively referred to as a first signal port), such as a DB9F connector for example. Pin-2 at connector 200 is used by microcontroller 112 to transfer serial data to computer 170. Pin-3 at connector 200 is used by computer 170 to transfer serial data to microcontroller 112. Pin-7 at connector 200 is used for a Clear-to-Send signal that is used to reset microcontroller before each operation. Pin-5 at connector 200 is grounded to signal ground. Pin-4 at connector 200, the DTR (data transfer rate) pin, is used for PSEN (program store enable) signaling for reprogramming microcontroller 112 through PSEN network 210. As used herein, a “pin-number” designation is used to denote a terminal or connection point of an architectural element of interface 110 as depicted in FIGS. 3-13.

Pin-2, pin-3, and pin-7 of connector 200 are all connected to microchip 220, which acts as a middleman between computer 170 and microcontroller 112 for changing or converting the logical 0 and logical 1 voltage levels appropriately so that microcontroller 112 can communicate with computer 170. For example, in RS232 protocol, a logical 0 has a voltage level of +5 VDC (volts direct current) not to exceed +15 VDC, and a logical 1 has a voltage level of −5 VDC not to exceed −15 VDC, however, microcontroller 112 recognizes a logical 0 as 0 VDC and a logical 1 as +5 VDC. Accordingly, microchip 220 serves to convert the logical signals from one voltage format into the other, and vice versa. Capacitors C3, C6, C10, C11 and C12, collectively depicted as capacitor network 230 in FIG. 2, are used by the internal charge pumps of microchip 220 to increase the incoming voltage levels from microcontroller 112 to computer 170. Capacitor C10 is a filtering capacitor at the power pin of microchip 220, and provides +5 VDC supply should the supplied voltage briefly drop below +5 VDC. Other capacitors may be employed at other integrated circuit chip power input pins for the same purpose.

A sub-circuit 240, including resistors R53 and R56, transistor Q7, and diode D15, is used to turn on and off the power light LED (light emitting diode) D15. When interface 110 is powered and is not receiving a reset command from computer 170, LED D15 is on, thereby indicating that microcontroller 112 is ready to receive commands from computer 170.

A sub-circuit 250 (alternatively referred to as a reset network), including resistors R6, R7, R8 and R20, diodes D2 and D11, and comparator U2C, is used to control the reset function of microcontroller 112. When computer 170 sends a reset command, signifying a user request to program motor control 120, diode D11 will conduct and the voltage level at the negative input pin-8 of comparator U2C will drop below the voltage level of the positive pin-9 of comparator U2C, causing comparator U2C to turn on, which allows a +5 VDC to travel through resistor R20 to the reset input pin-10 of microcontroller 112, thereby causing microcontroller 112 to reset. When computer 170 does not send a reset signal, diode D11 does not conduct, thereby keeping the voltage level at the negative pin-8 of comparator U2C higher than the voltage level at the positive pin-9 of comparator U2C, which results in comparator U2C entering its high impedance state that keeps the +5 VDC from reaching the reset pin-10 of microcontroller 112. In this manner, diode D11 acts as a reset control element responsive to a reset command from computer 170 and used for controlling the reset action of microcontroller 112.

Diodes D13 and D14 of sub-circuit 260 are status lights. When interface 110 is ready to accept commands from computer 170, the green LED D13 will light up with a command from microcontroller 112. When the red LED D14 is lit, via another command from microcontroller 112, interface 110 is not ready to accept commands from computer 170 as it is currently executing a task.

The crystal X1 of sub-circuit 270 defines the operating speed of microcontroller 112, and in an exemplary embodiment is an 11.0592 MHz (Mega-Hertz) crystal. Capacitors C7 and C8 of sub-circuit 270 are used for noise filtering.

An arrangement of 8-pin dip-switches 280, in conjunction with the resistor bank 290, are used to either send +5 VDC signals to the P2 (port-2) pins of microcontroller 112 or to make a connection to ground. Some pins of the dip-switches 280 are used to set the communication baud rate of interface 110, with the default being 2400 baud, while other pins are for employing optional features. In the absence of optoelectric isolators in the plurality of signal communication paths between connector 200 and connector 430, the baud rate throughput of interface 110 is limited only by the hardware of interface 110, which in an exemplary embodiment is 120 kbps (kilobits per second). In an embodiment, the baud rate throughput of interface 110 is equal to or greater than 2400 baud, and preferably equal to or greater than 4800 baud.

The initial firmware installation at microcontroller 112 involves grounding the PSEN-pin of microcontroller 112. PSEN network 210, including resistors R36 and R57, diode D16, and transistor Q4, forms the transistor logic for performing the PSEN High/Low logic in conjunction with the DTR-pin of the serial communication port at computer 170. Grounding the PSEN-pin of microcontroller 112 will cause microcontroller 112 to go into bootloader mode, at which time microcontroller 112 can be reprogrammed. During normal operation, a +5 VDC is supplied to the PSEN-pin of microcontroller 112.

The four output lines 300 (labeled R, W/W2, BK/PWM and G) that are in signal communication with sub-circuits 310, 320, 330 and 340, respectively, are directed to motor control 120 and are connected to pins P0.4, P0.5, P0.6 and P0.7 of microcontroller 112, respectively. These four output lines 300 are used to place motor control 120 in test mode and to reprogram memory 122 of motor control 120. The four output lines 300 have pull-up resistors (R39, R41, R42 and R43) 350 to strengthen the signal coming from microcontroller 112 and to establish the logical 1 voltage at +5 VDC. After the signal strength has been increased, via pull-up resistors 350, the signal enters the negative pin of a comparator (pin-6 of comparator U3A of sub-circuit 310, for example) where it is compared against a voltage level of +2.5 VDC in order to filter out noise. Any voltage value below +2.5 VDC entering the negative pin of the comparator will be treated as a logical 0. In response to there being a +5 VDC voltage at the negative pin of the comparator, the comparator will enter its high impedance state that causes a voltage level of 0 VDC to be seen by the gate of the pnp-transistor (transistor Q3 of sub-circuit 310, for example). With 0 VDC at the gate of pnp-transistor, the transistor will conduct, sending a +20 VDC signal to motor control 120. The reverse happens if the negative pin of the comparator is less than +2.5 VDC. Diodes D3, D4, D5 and D6, of sub-circuits 310, 320, 330 and 340, respectively, are transzorbs used for transient protection. While reference is made above to comparator U3A and transistor Q3 of sub-circuit 310, one skilled in the art will readily appreciate that comparators U3B, U3C and U3D, and transistors Q1, Q2 and Q4, of sub-circuits 320, 330 and 340, respectively, function in a similar manner as described above.

The cable check line (labeled C1/C2/RPM(−)) 360 is the incoming line from motor control 120 to microcontroller 112 via sub-circuit 370 (sub-circuit 370 includes resistors R5, R9 and R23, capacitor C1, and comparator U2A) that carries the data of the cable-check test and the opto (optoelectric isolator) test. When a cable test is performed, microcontroller 112 turns on each of the output lines 300 one at a time, whereby the voltage flows through motor control 120 and travels back into interface 110 via the cable check line 360. The incoming voltage is seen at the positive pin-7 of comparator U2A after resistors R5 and R9 have strengthened the signal. If this incoming voltage is greater than the threshold voltage at the negative pin-6 of comparator U2A, comparator U2A will turn on, sending a +5 VDC voltage to microcontroller 112, thereby giving the cable-check test a positive result. However, if the line is broken or the cable is not connected to both the motor 130 and the motor control 120, the voltage seen by the positive pin-7 of comparator U2A will not be greater than the voltage seen by the negative pin-6 of comparator U2A, thereby resulting in comparator U2A entering its high impedance state, causing 0 VDC to be seen at microcontroller 112 on the cable-check line 360 at pin P1.3 of microcontroller 112, and causing the test to fail. The resistor network (alternatively referred to as resistor ladder or an impedance network) (R40, R44, R45, R46, R47, R50, R51 and R52) 380 connected to the negative pin-6 of comparator U2A of sub-circuit 370 sets the threshold voltage level with four signals from microcontroller 112, thereby enabling the user to change the threshold voltage level of comparator U2A through software rather than hardware. In an embodiment where computer 170 is in signal communication with the Internet, the threshold voltage level of comparator U2A may be downloaded via the Internet.

The RPM(+) line 390 is the incoming data line from motor control 120. The RPM(+) line 390 carries the data from memory 122, an EEPROM chip for example, at motor control 120 through microcontroller 112 via sub-circuit 400 to computer 170 during a memory read operation. RPM(+) line 390 is also used by microcontroller 112 to extract data from motor control 120 during a memory write operation that should not be lost during this process, which may include such data as the serial number of motor control 120, calibration data, and horsepower rating, for example. Sub-circuit 400 also serves to eliminate noise while allowing actual motor signals to pass through, thereby preventing noise from passing as actual data.

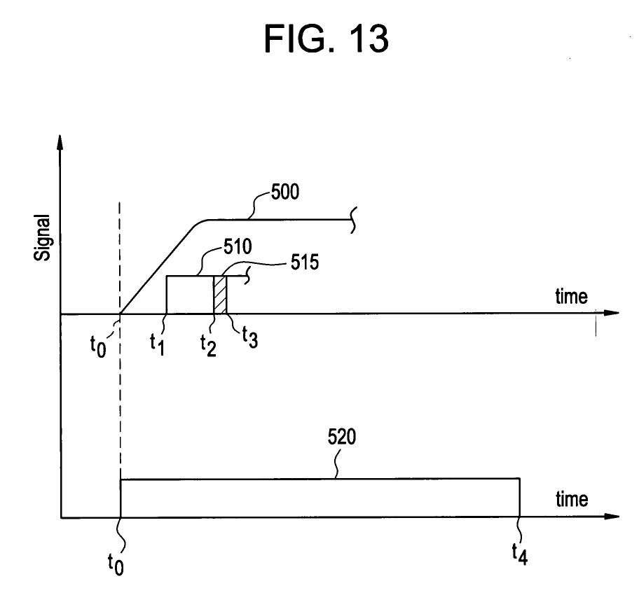

A solid-state relay (SSR) U1 and associated circuitry, depicted as sub-circuit 410, controls when motor control 120 receives 24 VAC power from transformer 150. When SSR U1 receives a 0 VDC signal from microcontroller 112, the internal diode 411 conducts closing the circuit and allowing the 24 VDC to pass through SSR U1 and into motor control 120 via power lines 420. If +5 VDC signal is sent by microcontroller 112 to SSR U1, diode 411 will not conduct keeping the circuit open, thereby preventing motor control 120 from receiving any power. In this manner, diode 411 acts as a control element responsive to first and second signals from microcontroller 112 for turning on power and for turning off power to motor control 120. By employing SSR U1, microcontroller 112 can control when motor control 120 may enter its test mode, and since motor control 120 may only be programmed while it is in test mode, microcontroller 112 can also control when motor control 120 may be programmed. Motor control 120 may only enter its test mode if it receives an appropriate command from microcontroller 112 within a defined time after it receives power, and if this defined time window expires, motor control 120 will not enter its test mode even if it receives the command to do so from microcontroller 112, thereby preventing motor control 120 from being programmed. A consequence of employing SSR U1 is that power may run through the signal cables if no programming signal is recognized inside the defined time window. In an embodiment, the defined time window is equal to or less than 700-milliseconds (ms), which is best seen by now referring to FIG. 13. In FIG. 13, an applied power signal 500 to motor 130, a microcontroller timing sequence 510, 515 at microcontroller 112, and a programming mode request signal 520 between interface 110 and motor 130 are depicted. At time t0, a power signal 500 is applied to motor 130, and interface 110 sends a programming mode request signal 520 to have motor 130 enter test mode (or programming mode). The duration of programming mode request signal 520 is from time t0 to time t4, which in an embodiment is 700 ms. Between time t0 and time t1, interface capacitors are charged. At time t1, microcontroller 112 is powered up with a +5 VDC signal and a reset command is executed. At time t2, microcontroller 112 exits reset mode and clears its RAM (random access memory). In an embodiment, time t2 is approximately 100 ms after time t0, but this duration may vary depending on motor, power source and other system design parameters. After clearing RAM, microcontroller 112 checks the status of its inputs and registers whether a programming mode request signal 520 is present. Microcontroller 112 acknowledges the presence of signal 520, if it is present, by time t3. In an embodiment, the time duration between time t2 and time t3 is approximately 60 ms. Microcontroller timing sequence 510, 515 must be completed before the programming mode request signal 520 times out (after 700 ms for example), otherwise motor 130 will enter run mode instead of test mode, and cannot be placed in test mode until another reset sequence is initiated.

Signal lines 300, 360 and 390, and power lines 420, terminate at connector 430 (alternatively referred to as a second signal port), which in an exemplary embodiment is an RJ45 connector, which in turn connects to the eight-wire signal/power line 140 for communication with motor control 120. Connector 430 includes signal terminals (depicted as T1-T6 on connector 430) adapted for sending a signal to and receiving a signal from motor control 120, and power terminals (depicted as T7-T8 on connector 430) adapted for sending power to motor control 120.

A power sub-circuit 440 includes four diodes D7, D8, D9 and D10, two resistors R34 and R37, three capacitors C5, C9 and C14, and two voltage regulator U5 and U7. The four diodes provide full wave rectification of the incoming AC power from transformer 150, and the two voltage regulators, one being adjustable through resistors R34 and R37 and one being fixed, provide regulated output voltage. The adjustable regulator U5 is set to output +20 VDC, and the fixed regulator U7 is set to output +5 VDC. The +20 VDC output is used for powering the comparators and for the output signals to motor control 120. The +5 VDC output is used for powering microcontroller 112 and microchip 220, and for strengthening the signals from and to microcontroller 112.

In an embodiment, microcontroller 112 includes onboard flash memory 114, such as 64 kB (kilobyte) EEPROM, for example, which is erasable and programmable, and enables circuit programming through computer 170, or the Internet where computer 170 is in signal communication with the Internet. An advantage of onboard flash memory 114 is that it eliminates the need for external ROM (read only memory) and it provides for upgrading and expansion of interface 110 without the need to purchase a new interface 110.

The program installed in microcontroller 112 is known as firmware, which is used for operating and controlling motor 130. The initial installation of the firmware involves the grounding of PSEN-pin through transistor logic at PSEN network 210 and DTR-pin of serial communication port at computer 170, as discussed above. However, upgrading of the firmware may be accomplished through computer 170 using the computer's serial port and application software. An advantage of the software-driven firmware upgrade is that the upgrade does not require any hardware changes, like DIP switch settings, for example. To upgrade the firmware, the end user need only to attach interface 110 to computer 170 through the use of a readily available serial cable.

In an embodiment where computer 170 is connected to the Internet, the end user may download new versions of the firmware through a website, which also provides the necessary driving software. Upon executing the driving software, the firmware is updated and the hardware is ready for use.

By providing reprogramming capability, interface 110 may be updated with new features for existing ECM designs, or with new drivers for new ECM designs.

In an embodiment employing interface 110, a method for programming motor control 120 includes receiving a reset signal at sub-circuit 250 from computer 170, the reset signal being representative of a user request to program motor control 120, and in response thereto, generating a ready signal at sub-circuit 240 and turning on power via sub-circuit 410 to motor control 120. Following the power-up of motor control 120, successful programming continues by receiving a programming signal from computer 170 within a defined time, such as 10 milliseconds for example, following the power being turned on to motor control 120, and then receiving and communicating the programming signals from computer 170 to motor control 120. In response to the programming signal from computer 170 being received at interface 110 outside of the defined time following the power being turned on to motor control 120, interface 110 prevents motor control 120 from entering its test mode and from acting upon any received programming signals.

In an embodiment employing interface 110, microcontroller 112 includes executable instructions for testing a two-line (positive and negative line) optoelectric isolator in motor 130. In response to a request from computer 170 to test the first line, such as the negative line of optoelectric isolator, microcontroller 112 sends out a test signal, similar to the approach discussed above regarding the cable-check test, and receives in response a test result signal that is representative of the state of the optoelectric isolator. However, in response to a request from computer 170 to test the second line, such as the positive line, microcontroller 112 provides a pass verification signal independent of the state of the optoelectric isolator, thereby always returning a positive test result to computer 170 for the second line. By employing this pass verification technique on the second line, interface 110 is capable of testing up to eight two-line optoelectric isolators (sixteen lines) using only one eight-line connector 430.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. An interface for programming a motor control of a motor, comprising:
a microcontroller in signal communication with a first signal port and a second signal port, the first signal port adapted for receiving a signal from a computer, the second signal port having a signal terminal adapted for sending a signal to the motor control and a power terminal adapted for sending power to the motor control; and
a solid state relay in signal communication with the microcontroller and the power terminal, the solid state relay having a control element responsive to first and second signals from the microcontroller for turning on power and for turning off power, respectively, to the motor control;
wherein the microcontroller is adapted for sending a programming signal from the computer to the motor control in response to the programming signal being sent within a defined time following the control element turning on power to the motor control.

2. The interface of claim 1, further comprising:
a plurality of signal paths for communicating signals between the first signal port and the second signal port, each signal path adapted for signal communication at a baud rate equal to or greater than 2400 baud.

3. The interface of claim 2, wherein:
each signal path is absent an optoelectric isolator.

4. The interface of claim 1, further comprising:
a comparator in signal communication with the second signal port and the microcontroller;
wherein an output of the comparator is representative of a cable connection state between the motor control and the motor;
wherein an input value to the comparator is compared against a threshold value;
wherein the output of the comparator is representative of the cable connection state being open in response to the threshold value exceeding the input value.

5. The interface of claim 4, further comprising:
an impedance network in signal communication with the comparator and the microcontroller;
wherein the impedance of the impedance network is responsive to the microcontroller, and the value of the threshold level is responsive to the impedance of the impedance network.

6. The interface of claim 5, wherein:
the impedance of the impedance network is adjustable by a user via a signal from the computer.

7. The interface of claim 6, wherein:
the computer is adapted for signal communication with the Internet.

8. The interface of claim 1, wherein:
the microcontroller further comprises erasable and programmable memory for storing firmware used for operating and controlling the motor;
wherein the firmware is upgradeable via the computer.

9. The interface of claim 8, wherein:
the computer is adapted for signal communication with the Internet.

10. The interface of claim 1, further comprising:
a signal converter in signal communication with the microcontroller and the first signal port for converting a logical 0 signal and a logical 1 signal from an RS232 format to a format recognizable by the microcontroller, and vice versa.

11. The interface of claim 1, further comprising:
first and second status lights in signal communication with and responsive to the microcontroller, the first status light representative of the interface being ready to accept commands from the computer, the second status light representative of the interface not being ready to accept commands from the computer.

12. The interface of claim 1, wherein:
the second signal port consists of eight terminals, wherein six of the eight terminals may function as signal terminals and two of the eight terminals may function as power terminals.

13. The interface of claim 1, wherein:
the defined time is equal or less than 10 milliseconds.

14. The interface of claim 1, further comprising:
a reset network in signal communication with the first signal port and the microcontroller, the reset network having a reset control element, the reset control element being responsive to a reset command from the computer, and the microcontroller being responsive to the reset control element;
wherein a reset command signal received at the reset control element from the computer results in a reset signal being received at the microcontroller and a ready signal being generated by the microcontroller, the ready signal indicating that the interface is ready to accept commands from the computer.

15. A method for programming a motor control of motor, comprising:
receiving at an interface a reset signal from a computer, the reset signal representative of a user request to program the motor control;
in response to the reset signal, generating a ready signal at the interface and turning on power at the interface to the motor control;
receiving at the interface a programming signal from the computer within a defined time following the power being turned on to the motor control; and
receiving and communicating via the interface the programming signal from the computer to the motor control.

16. The method of claim 15, further comprising:
in response to the programming signal from the computer being received at the interface outside of the defined time following the power being turned on to the motor control, preventing the motor control from entering a test mode and from acting upon the programming signal.

17. The method of claim 15, further comprising:
receiving at the interface a logical 0 and a logical 1 signal from the computer in RS232 format;
converting the logical 0 and logical 1 signals received from the computer from RS232 format to a format recognizable by a microcontroller at the interface; and
sending the converted signals to the microcontroller for processing.

18. The method of claim 15, further comprising:
sending from the interface a cable test signal on a signal line to the motor control, and receiving in response thereto a return test signal on a cable check line;
comparing the value of the return test signal to a comparator threshold value; and
in response to the comparator threshold value exceeding the value of the return test signal, providing a cable test failure signal.

19. The method of claim 18, further comprising:
adjusting the comparator threshold value via the computer.

20. The method of claim 19, wherein:
the computer is adapted for signal communication with the Internet.

21. The method of claim 15, wherein the receiving and communicating via the interface the programming signal from the computer to the motor control, further comprises:
communicating the programming signal from the computer to the motor control at a baud rate equal to or greater than 2400 baud.

22. The method of claim 21, wherein the communicating the programming signal from the computer to the motor control, further comprises:
communicating the programming signal from the computer to the motor control in the absence of an optoelectric isolator.

23. The method of claim 15, further comprising:
receiving at the interface a request from the computer to perform an optoelectric isolator test on first and second lines of an optoelectric isolator at the motor;
in response to the received request for the first line, performing the optoelectric isolator test on the first line and providing a test result signal representative of the state of the optoelectric isolator; and
in response to the received request for the second line, providing a pass verification signal independent of the state of the optoelectric isolator.

24. The method of claim 15, further comprising:
receiving at the interface upgraded firmware from the computer; and
storing the upgraded firmware at an erasable and programmable memory at a microcontroller at the interface.

25. The method of claim 24, wherein:
the computer is adapted for signal communication with the Internet.

26. A method for testing a cable connection between an interface and a motor control, comprising:
receiving at an interface a cable test request signal from a computer;
sending from the interface a cable test signal on a signal line to the motor control, and receiving in response thereto a return test signal on a cable check line;
comparing the value of the return test signal to a comparator threshold value; and
in response to the comparator threshold value exceeding the value of the return test signal, providing a cable test failure signal.

27. The method of claim 26, further comprising:
adjusting the comparator threshold value via the computer.

28. The method of claim 27, wherein:
the computer is adapted for signal communication with the Internet.
